(19) United States
(12) Patent Application Publication
(10) Pub. No.: US 2019/0347241 A1
(43) Pub. Date: Nov. 14, 2019

(54) DISTRIBUTED SYSTEM

(71) Applicant: TURBO DATA LABORATORIES, INC., Kanagawa (JP)

(72) Inventor: Shinji Furusho, Kanagawa (JP)

(21) Appl. No.: 16/464,677

(22) PCT Filed: Nov. 15, 2017
(86) PCT No.: PCT/JP2017/041159

§ 371 Date: May 28, 2019

(30) Foreign Application Priority Data
Nov. 28, 2016 (JP) 2016-230213

(51) Int. Cl. G06F 15/78

(52) U.S. Cl. CPC G06F 15/78

(57) ABSTRACT

To complete transfer of data of a node to all other nodes in a short time while suppressing the number of channels. A distributed processing system is formed by a plurality of rings. In addition, each ring is formed by sequentially connecting the same number of nodes in a ring shape by channels. In addition, the nodes of each ring are connected to a node having the same order on the ring of the other rings by a channel. Each node transmits data, which is received from the node immediately previous in the order on the ring, to a node next in the order on the ring and a node having the same order in the ring of other rings.

### FIELD OF THE INVENTION

The present invention relates to a technique of data transfer in a distributed system (distributed processing system) including a plurality of nodes.

### BACKGROUND OF THE INVENTION

In a distributed processing system including a plurality of nodes, when processing target data is divided and allocated to each node to process the data, each node may collect information from all the other nodes.

As one of techniques of collecting information in each node of such a distributed processing system from all the other nodes, in a distributed processing system where a table composed of a plurality of records is divided in the unit of record and allocated to each node which processes a part of each record to which processing to the table in each node is allocated, when performing a sorting operation using a value of the record as a key as a process on the table, there is known a technique of collecting information on the number of records allocated to other nodes for each record value allocated to the other nodes from each of the other nodes and calculating the order in the table of each record assigned to itself (see, e.g., WO 2005/073880).

In this technique, as illustrated in FIG. 22A, nodes (N0, N1, N2, and N3) are connected to each other in a ring shape by bidirectional channels to form a ring type network, and, as illustrated in FIG. 22B, information is sequentially relayed along the ring at each node so that the information transmission source node transfers the information created in the ring to all the other nodes.

### SUMMARY OF THE INVENTION

According to the technique of transferring information using the ring type network illustrated in FIG. 22A, the number of channels maybe small, but as the number of nodes increases, it takes a long time from the transmission of the information of the transmission source node to the completion of the transfer of the information to all the other nodes, which may result in deterioration of the process response.

Meanwhile, as illustrated in FIG. 22C, when a full connection type network configuration in which each node is connected directly to all the other nodes by channels is adopted so that the transmission source node transfers information directly to all the other nodes, the time required to complete the transfer may be shortened. However, when the number of nodes increases, the number of required channels also increases dramatically.

An object of the present invention is to provide a distributed processing system capable of completing transfer of information of a node to all other nodes in a relatively short time while suppressing the number of channels.

According to an aspect of the present invention, there is provided a distributed processing system in which a plurality of nodes are connected by a channel, including: a plurality of rings, each having n nodes (where n is an arbitrary natural number equal to or greater than 2) connected in a ring shape by channels, wherein the number of nodes included in each ring is equal, and each node of each ring is connected by a channel having a relevant node as a transmitting side such that a node of each ring other than a ring including the relevant node and each node included in the same ring are respectively connected to different nodes of another ring by the channel having the relevant node as the transmitting side.

According to the configuration of the distributed processing system described above, data of a node may be transferred to all the other nodes while reducing the maximum value of the number of hops expressed as the number of nodes passed by data, as compared with the ring type network in which all the nodes included in the distributed processing system are connected to each other in a ring shape. Therefore, the time taken to complete the transfer of data of a node to all the other nodes may be reduced. Meanwhile, the number of required channels is small, as compared with the full connection type network in which each node is connected directly to all the other nodes by channels.

Further, the load of each channel between nodes in the same ring or the load of each channel between nodes of different rings may be relatively equalized.

Thus, the transfer of data of a node to all the other nodes may be completed in a relatively short time while suppressing the number of channels.

More specifically, for example, each node of each ring of the distributed processing system may include a transfer control unit configured to transfer data, which is received from a channel connected to a node previous to the relevant node in the connection order on the ring including the relevant node, to a channel connected to a node next to the relevant node in the connection order on the ring including the relevant node, and a channel which has the relevant node as a transmitting side and is connected to a node included in another ring other than the ring including the relevant node.

In addition, each node of each ring of the distributed processing system may include a transfer control unit configured to transmit data of which a transmission source is the relevant node, to a channel connected to a node next to the relevant node in the connection order on the ring including the relevant node, and a channel which has the relevant node as a transmitting side and is connected to anode included in another ring other than the ring including the relevant node, and configured to transfer data, of which a transmission source is not the relevant node, among the data received from a channel connected to a node previous to the relevant node in the connection order on the ring including the relevant node, to a channel connected to a node next to the relevant node in the connection order on the ring including the relevant node, and a channel which has the relevant node as a transmitting side and is connected to a node included in another ring other than the ring including the relevant node.

In addition, each node of each ring of the distributed processing system may include a transfer control unit configured to transfer data, which is received from a channel connected to a node previous to the relevant node in the connection order on the ring including the relevant node, to a channel connected to a node next to the relevant node in the connection order on the ring including the relevant node, and configured to transfer data, which is received from a channel connected to a node of another ring, to a channel connected to a node next to the relevant node in the connection order on the ring including the relevant node.

In addition, each node of each ring of the distributed processing system may include a transfer control unit configured to transmit data of which a transmission source is the relevant node, to a channel connected to a node next to the relevant node in the connection order on the ring including the relevant node and a channel which has the relevant node as a transmitting side and is connected to anode included in another ring other than the ring including the relevant node, configured to transfer data, which is received from a channel connected to a node of another ring, to a channel connected to a node next to the relevant node in the connection order on the ring including the relevant node, and configured to transfer data of which a transmission source is not the relevant node and which is not transferred by the relevant node to a channel connected to the node next to the relevant node in the connection order on the ring including the relevant node, among the data received from a channel connected to a node previous to the relevant node in the connection order on the ring including the relevant node, to a channel connected to a node next to the relevant node in the connection order on the ring including the relevant node.

Here, the distributed processing system may be configured such that, assuming that the connection order of a node on a ring is the order of the relevant node, the j^{th} node (where j is an arbitrary natural number equal to or smaller than n) of each ring is connected to a j^{th} node of each of other rings by a channel having the relevant node as a transmitting side.

In addition, the distributed processing system may be configured such that, assuming that the connection order of nodes on a ring is the order of the nodes, the j^{th} node (where j is an arbitrary natural number smaller than n) of each ring is connected to the (j+1)^{th} node of each of other rings by a channel having the relevant node as a transmitting side, and an n^{th} node of each ring is connected to the first node of each of other rings by a channel having the relevant node as a transmitting side.

According to another aspect of the present invention, there is provided a distributed processing system in which a plurality of nodes are connected to each other by channels, the distributed processing system including: m rings (where m is an arbitrary natural number equal to or greater than 2) each having n nodes (where n is an arbitrary natural number equal to or greater than 2) connected to each other in a ring shape by channels, wherein the number of nodes included in each ring is equal, and each node of an i^{th} ring (where i is an arbitrary natural number equal to or smaller than m) is connected to each of different nodes of an (i−1)^{th} ring by a channel having the relevant node as a transmitting side when the (i−1)^{th} ring exists, and each of different nodes of an (i+1)^{th} ring by a channel having the relevant node as a transmitting side when the (i+1)^{th} ring exists.

According to the configuration of the distributed processing system described above, data of a node may be transferred to all the other nodes while reducing the maximum value of the number of hops expressed as the number of nodes passed by data, as compared with the ring type network in which all the nodes included in the distributed processing system are connected to each other in a ring shape. Therefore, the time taken to complete the transfer of data of a node to all the other nodes may be reduced. Meanwhile, the number of required channels is small, as compared with the full connection type network in which each node is connected directly to all the other nodes by channels.

Thus, the transfer of data of a node to all the other nodes may be completed in a relatively short time while suppressing the number of channels.

More specifically, for example, each node of the i^{th} ring of the distributed processing system may include a transfer control unit configured to transfer data, which is received from a channel connected to a node previous to the relevant node in the connection order on the i^{th} ring, to a channel connected to a node next to the relevant node in the connection order on the i^{th} ring, a channel which has the relevant node as a transmitting side and is connected to a node of the (i−1)^{th} ring when the (i−1)^{th} ring exists, a channel which has the relevant node as a transmitting side and is connected to a node of an (i+1)th ring when the (i+1)^{th} ring exists, configured to transfer data, which is received from a channel connected to the node of the (i−1)^{th} ring, to a channel which has the relevant node as a transmitting side and is connected to the node of the (i+1)^{th} ring when the (i+1)^{th} ring exists, and configured to transfer data, which is received from a channel connected to the node of the (i+1)^{th} ring, to a channel which has the relevant node as a transmitting side and is connected to the node of the (i−1)^{th} ring when the (i−1)^{th} ring exists.

In addition, each node of the i^{th} ring of the distributed processing system may include a transfer control unit configured to transfer data, of which a transmission source is the relevant node, to a channel connected to a node next to the relevant node in the connection order on the i^{th} ring, a channel which has the relevant node as a transmitting side and is connected to anode of an (i−1)^{th} ring when the (i−1)^{th} ring exists, and a channel which has the relevant node as a transmitting side and is connected to a node of an (i+1)^{th} ring when the (i+1)^{th} ring exists, configured to transfer data, of which a transmission source is not the relevant node, among the data received from a channel connected to a node previous to the relevant node in the connection order on the i^{th} ring, to a channel connected to a node next to the relevant node in the connection order on the i^{th} ring, a channel which has the relevant node as a transmitting side and is connected to a node of the (i−1)^{th} ring when the (i−1)^{th} ring exists, and a channel which has the relevant node as a transmitting side and is connected to a node of the (i+1)^{th} ring when the (i+1)^{th} ring exists, configured to transfer data, which is received from a channel connected to the node of the (i−1)^{th} ring, to a channel which has the relevant node as a transmitting side and is connected to the node of the (i+1)^{th} ring when the (i+1)^{th} ring exists, and configured to transfer data, which is received from a channel connected to the node of the (i+1)^{th} ring, to a channel which has the relevant node as a transmitting side and is connected to the node of the (i−1)^{th} ring when the (i−1) ring exists.

Each node of the i^{th} ring of the distributed processing system may include a transfer control unit configured to transfer data, which is received from a channel connected to a node previous to the relevant node in the connection order on the i^{th} ring, to a channel connected to a node next to the relevant node in the connection order on the i^{th} ring, configured to transfer data, which is received from a channel connected to a node of the (i−1)^{th} ring, to a channel connected to a node next to the relevant node in the connection order on the i^{th} ring, and a channel which has the relevant node as a transmitting side and is connected to a node of the (i+1)^{th} ring when the (i+1)^{th} ring exists, and configured to transfer data, which is received from a channel connected to a node of the (i+1)^{th} ring, to a channel connected to a node next to the relevant node in the connection order on the i^{th} ring, and a channel which has the relevant node as a transmitting side and is connected to a node of the (i−1)^{th} ring when the (i−1)^{th} ring exists.

Each node of the i^{th} ring of the distributed processing system may include a transfer control unit configured to transmit data, of which a transmission source is the relevant node, to a channel connected to a node next to the relevant node in the connection order on the i^{th} ring, configured to transfer the data to a channel which has the relevant node as a transmitting side and is connected to a node of the (i−1)^{th} ring when the (i−1)^{th} ring exists and a channel which has the relevant node as a transmitting side and is connected to a node of the (i+1)^{th} ring when the (i+1)^{th} ring exists, configured to transfer data, which is received from a channel connected to a node of the (i−1)^{th} ring, to a channel connected to a node next to the relevant node in the connection order on the i^{th} ring, and a channel which has the relevant node as a transmitting side and is connected to a node of the (i+1)^{th} ring when the (i+1)^{th} ring exists, configured to transfer data, which is received from a channel connected to a node of the (i+1)^{th} ring, to a channel connected to a node next to the relevant node in the connection order on the i^{th} ring, and a channel which has the relevant node as a transmitting side and is connected to a node of the (i−1)th ring when the (i−1)^{th} ring exists, and configured to transfer data, of which a transmission source is not relevant node and which is not transferred to a channel connected to the node next to the relevant node in the connection order on the i^{th} ring, among the data received from a channel connected to a node previous to the relevant node in the connection order on the i^{th} ring, to a channel connected to a node next to the relevant node in the connection order on the i^{th} ring.

In the distributed processing system, assuming that the connection order of a node on a ring is the order of the relevant node, the j^{th} node (where j is an arbitrary natural number equal to or smaller than n) of the i^{th} ring (where i is an arbitrary natural number equal to or smaller than m) may be connected to the j^{th} node of the (i−1)^{th} ring by a channel having the relevant node as a transmitting side when the (i−1)^{th} ring exists, and may be connected to the j^{th} node of the (i+1)^{th} ring by a channel having the relevant node as a transmitting side when the (i+1)^{th} ring exists.

In the distributed processing system, assuming that the connection order of a node on a ring is the order of the relevant node, the j^{th} node (where j is an arbitrary natural number smaller than n) of the i^{th} ring may be connected to the (j+1)^{th} node of the (i−1)^{th} ring by a channel having the relevant node as a transmitting side when the (i−1)^{th} ring exists, the n^{th} node of the i^{th} ring may be connected to the first node of the (i−1)^{th} ring by a channel having the relevant node as a transmitting side, the j^{th} node of the i^{th} ring may be connected to the (j+1)^{th} node of the (i+1)^{th} ring by a channel having the relevant node as a transmitting side when the (i+1)^{th} ring exists, and the n^{th} node of the i^{th} ring may be connected to the first node of the (i+1)^{th} ring by a channel having the relevant node as a transmitting side.

The distributed processing system may further include a switch configured to change the connection of channels so that the distributed processing system is divided into the plurality of distributed processing systems described above, each having fewer nodes included in each ring than the distributed processing system.

As described above, according to the present invention, it is possible to provide a distributed processing system capable of completing transfer of information of a node to all other nodes in a relatively short time while suppressing the number of channels.

### BRIEF DESCRIPTION OF THE DRAWINGS

FIG. 1 is a view illustrating the configuration of a distributed processing system according to a first exemplary embodiment of the present invention;

FIG. 2 is a block diagram illustrating the configuration of a node according to the first exemplary embodiment of the present invention;

FIG. 3 is a block diagram illustrating the configuration of buffers of a transfer control device according to the first exemplary embodiment of the present invention;

FIGS. 4A to 4C are views illustrating the state of data transfer of the distributed processing system according to the first exemplary embodiment of the present invention;

FIGS. 5A and 5B are views illustrating the state of data transfer of the distributed processing system according to the first exemplary embodiment of the present invention;

FIGS. 6A to 6D are views illustrating the state of data transfer of the distributed processing system according to the first exemplary embodiment of the present invention;

FIG. 7 is a block diagram illustrating a buffer configuration of a transfer control device according to a second embodiment of the present invention;

FIGS. 8A to 8C are views illustrating the state of data transfer of a distributed processing system according to the second exemplary embodiment of the present invention;

FIGS. 9A and 9B are views illustrating the state of data transfer of the distributed processing system according to the second exemplary embodiment of the present invention;

FIGS. 10A to 10C are views illustrating another exemplary configuration of the distributed processing system according to the first and second exemplary embodiments of the present invention;

FIGS. 11A to 11C are views illustrating another exemplary configuration of the distributed processing system according to the first and second exemplary embodiments of the present invention;

FIGS. 12A to 12D are views illustrating another exemplary configuration of the distributed processing system according to the first and second exemplary embodiments of the present invention;

FIG. 13 is a view illustrating the configuration of a distributed processing system according to a third exemplary embodiment of the present invention;

FIG. 14 is a block diagram illustrating a buffer configuration of a transfer control device according to the third embodiment of the present invention;

FIGS. 15A to 15C are views illustrating the state of data transfer of the distributed processing system according to the third exemplary embodiment of the present invention;

FIGS. 16A to 16C are views illustrating the state of data transfer of the distributed processing system according to the third exemplary embodiment of the present invention;

FIGS. 17A to 17C are views illustrating the state of data transfer of the distributed processing system according to the third exemplary embodiment of the present invention;

FIGS. 18A and 18B are views illustrating the state of data transfer of the distributed processing system according to the third exemplary embodiment of the present invention;

FIG. 19 is a block diagram illustrating a buffer configuration of a transfer control device according to a fourth exemplary embodiment of the present invention;

FIGS. 20A and 20B are views illustrating the state of data transfer of a distributed processing system according to the fourth exemplary embodiment of the present invention;

FIG. 21 is a view illustrating another configuration example of the distributed processing system according to the third and fourth exemplary embodiments of the present invention; and

FIGS. 22A to 22C are views illustrating a known distributed processing system.

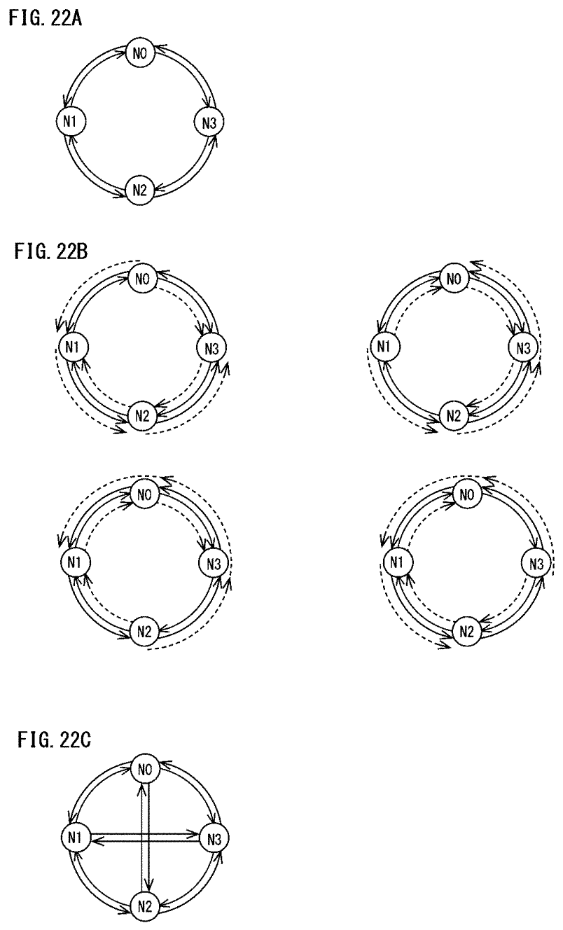

### DETAILED DESCRIPTION OF THE INVENTION

Hereinafter, exemplary embodiments of a distributed processing system according to the present invention will be described.

First, a first exemplary embodiment of the present invention will be described.

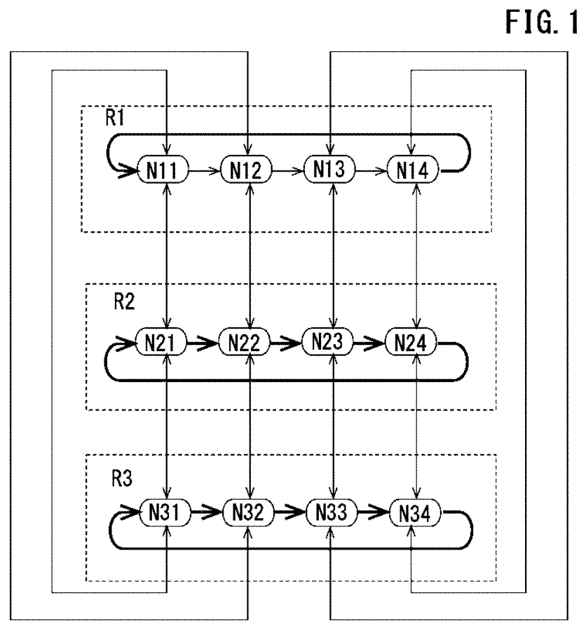

FIG. 1 illustrates the configuration of a distributed processing system according to the first exemplary embodiment.

As illustrated, the distributed processing system includes a plurality of rings (Ri), each of which includes the same number of nodes (Nij). In addition, Ri represents the i^{th} ring, and Nij represents the j^{th} node of the i^{th} ring.

That is, for example, in the illustrated example, the distributed processing system includes three rings (ring R1, ring R2, and ring R3), ring R1 includes nodes N11, N12, N13, and N14, ring R2 includes nodes N21, N22, N23, and N24, and ring R3 includes nodes N31, N32, N33, and N34.

In each of the rings, a ring-type network is formed in which the nodes included in the ring are sequentially connected to each other in a ring shape by channels.

That is, for example, in the illustrated example, in the ring R2, a ring type network is formed in which the nodes are connected to each other by channels in the order of N21-N22-N23-N24-N21.

The j^{th} node of the i^{th} ring is connected to the j^{th} node of each of the rings other than the i^{th} ring by a bidirectional channel.

That is, for example, in the illustrated example, the second node N12 of the ring R1 is connected to each of the second node N22 of the ring R2 and the second node N32 of the ring R3 by a channel, and the fourth node N24 of the ring R2 is connected to each of the fourth node N14 of the ring R1 and the fourth node N34 of the ring R3 by a channel.

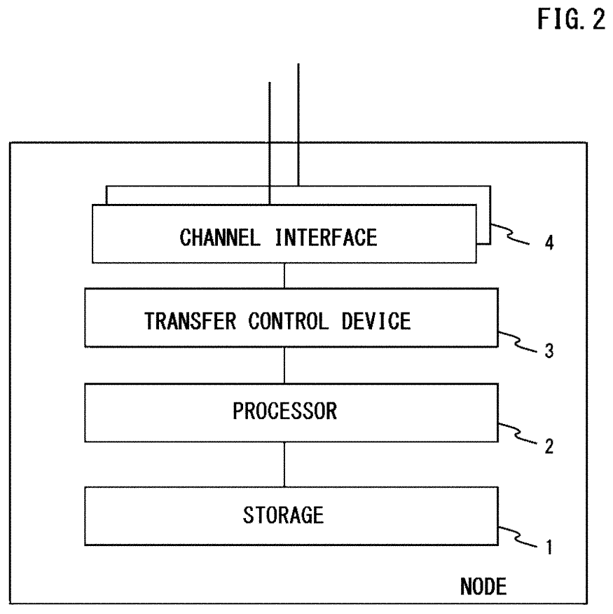

Next, FIG. 2 illustrates the configuration of each node.

As illustrated, each node includes a storage 1 and a processor 2, and may perform data processing independently from the other nodes by using the storage 1.

In order to exchange data with other nodes, the node includes a transfer control device 3 and a channel interface 4 provided for each channel for performing data transfer using a channel connected to the node. However, the transfer control device 3 may be provided in the node as a function implemented by execution of software by the processor 2.

Here, the transfer control device 3 controls relaying of data between each of the channels connected to the relevant node and the processor 2.

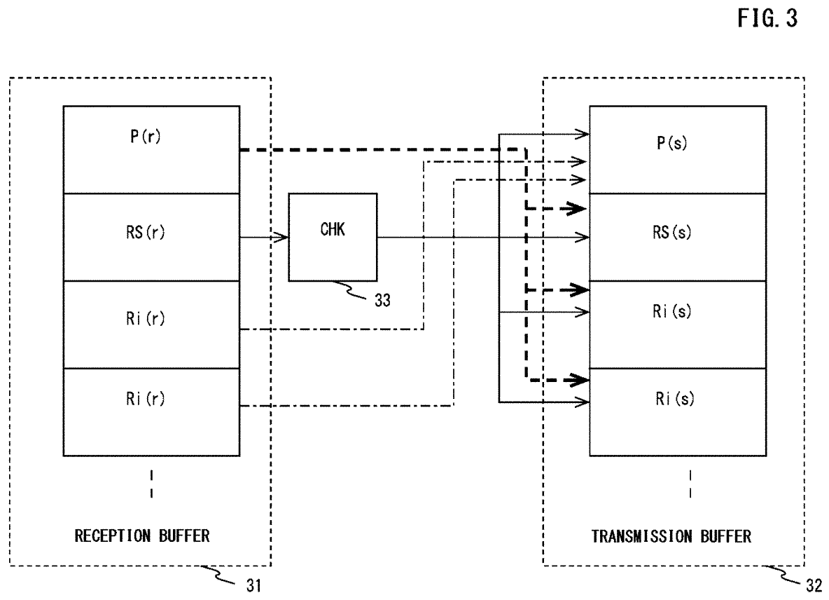

As illustrated in FIG. 3, the transfer control device 3 includes a reception buffer 31, a transmission buffer 32, and a duplicate transfer inhibition unit CHK33.

The reception buffer 31 includes a buffer P(r) that stores data to be transmitted to another node by the processor 2, and a buffer RS(r) that stores data received by the channel interface 4 from a node included in the same ring as that of the relevant node and previous to the relevant node in the order on the ring.

Here, “the order on the ring” refers to an order of nodes that are passed in the data transfer direction of the channel along the ring. In the case of the ring R2 illustrated in FIG. 1, a node previous to N21 is N24, and a node next to N21 is N22, a node previous to N22 is N21, and a node next to N22 is N23, a node previous to N23 is N22, and a node next to N23 is N24, and a node previous to N24 is N23, and a node next to N24 is N21.

Further, the reception buffer 31 includes buffers Ri(r) that store data received by the channel interface 4 from a node included in each of other rings different from the ring including the relevant node and having the same order as that of the relevant node in the order on the ring, and the number of the buffers Ri(r) is the same as the number of the other rings.

That is, for example, in the case of the third node N23 of the ring R2 in FIG. 1, data received from the node N22 is stored in the buffer RS(r). Further, the reception buffer 31 includes a buffer R1(r) in which data received from the third node N13 of the ring R1 is stored, and a buffer R3(r) in which data received from the third node N33 of the ring R3 is stored.

The transmission buffer 32 includes a buffer P(s) that stores data to be transmitted to the processor 2, and a buffer RS(s) that stores data to be transmitted via the channel interface 4 to a node included in the same ring as that of the relevant node and next to the relevant node in the order on the ring. The transmission buffer 32 includes buffers Ri(s) that stores data to be transmitted via the channel interface 4 to a node included in each of other rings different from the ring including the relevant node and having the same order as that of the relevant node in the order on the ring, and the number of the buffers Ri(s) is the same as that of the other rings.

That is, for example, in the case of the third node N23 of the ring R2 in FIG. 1, data to be transmitted to the node N24 is stored in the buffer RS(r). Further, the transmission buffer 32 includes a buffer R1(s) in which data to be transmitted to the third node N13 of the ring R1 is stored, and a buffer R3 (s) in which data to be transmitted to the third node N33 of the ring R3 is stored.

Then, the transfer control device 3 performs a transfer between buffers as follows.

That is, the data stored in the buffer P(r) of the reception buffer 31 by the processor 2 is transferred to the buffer RS (s) and each buffer Ri (s) of the transmission buffer 32 and is transmitted to a node included in the same ring as that of the relevant node and next to the relevant node in the order on the ring, and a node having the same order as that of the relevant node in each of other rings different from the ring including the relevant node.

Further, the data received from the node included in the same ring as that of the relevant node and previous to the relevant node in the order on the ring, and stored in the buffer RS (r) of the reception buffer 31 is transferred to the duplicate transfer inhibition unit CHK33. The duplicate transfer inhibition unit CHK33 determines whether or not the transferred data is data that was transmitted in the past by its own node as a transmission source to other nodes, and outputs the relevant data only when it is determined that the transferred data is not the data that was transmitted from its own node as a transmission source to the other nodes.

The determination on whether or not the data is data that was transmitted in the past by its own node as a transmission source to other nodes may be made, for example, by adding an identifier of the node of the transfer source to the data at the transfer source, transmitting the data, and setting the received data as data transmitted by its own node as a transmission source, to other nodes when the identifier added to the received data is the identifier of its own node. Alternatively, this determination may be made, for example, by adding a counter value to the data, incrementing the counter value of the data every time the data is transmitted/transferred at each node, and setting the received data as the data transmitted by its own node as a transmission source, to other nodes when the count value of the received data matches the number of nodes in the ring. As another alternative, in a case where the distributed processing system is configured so that each node as the transfer source transmits the data in synchronization, assuming that the number of nodes in the ring is M, this determination may be made by transmitting data whose transfer source is its own node, from a node and then setting M^{th} received data as the data transmitted by its own node as the transfer source to other nodes.

Then, the transfer control device 3 transfers the data output from the duplicate transfer inhibition unit CHK33 to the buffer P(s), the buffer RS(s), and each buffer Ri(s) of the transmission buffer 32, and transmits the relevant data to the processor 2, a node included in the same ring as that of the relevant node and next to the relevant node in the order on the ring, and a node included in each of other rings different from the ring including the relevant node and having the same order as that of the relevant node in the order on the ring.

Further, the data received from the node included in each of the other rings different from the ring including the relevant node and having the same order as that of the relevant node in the order on the ring, and stored in each Ri(r) is transferred to the buffer P(s) of the transmission buffer 32 and is transmitted to the processor 2.

The processor 2 receives and processes the data transmitted from the transfer control device 3 in this manner, that is, data that was not transmitted in the past from the processor 2 to other nodes, among the data received from the node included in the same ring as that of the relevant node and previous to the relevant node in the order on the ring, and the data received from the node included in other rings different from the ring including the relevant node and having the same order as that of the relevant node in the order on the ring.

Hereinafter, the data transfer operation implemented by the operation of the transfer control device 3 will be described.

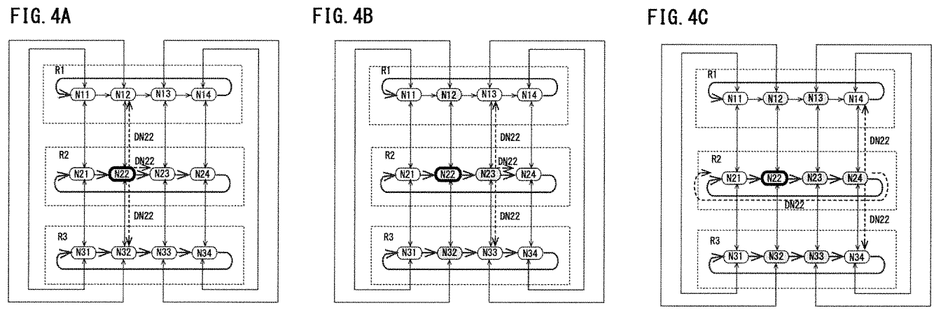

When data DN22 to be transferred from the processor 2 to other nodes occurs at the node N22 of the ring R2 as illustrated in FIG. 4A, the data DN22 is transferred from the node N22 to the node N23 next to the node N22 on the ring R2, and the node N12 of the ring R1 and the node N32 of the ring R3 which are nodes having the same order as that of the node N22 in the other rings. Then, at the node N23, the node N13, and the node N33, the data DN22 is fetched into the processor 2.

In each of the following figures, each round square representing a node to which the data DN22 is transferred is painted in gray.

Next, as illustrated in FIG. 4B, the node N23 to which the data DN22 is transferred from the node N22 transfers the transferred data DN22 to the node N24 next to the node N23 on the ring R2, and the node N13 of the ring R1 and the node N33 of the ring R3 which are nodes having the same order as that of the node N23 of other rings. Then, at the node N24, the node N13, and the node N33, the data DN22 is fetched into the processor 2.

Next, as illustrated in FIG. 4C, the node N24 to which the data DN22 is transferred from the node N23 transfers the transferred data DN22 to the node N21 next to the node N24 on the ring R2, and the node N14 of the ring R1 and the node N34 of the ring R3 which are nodes having the same order as that of the node N24 of other rings. Then, at the node N21, the node N14, and the node N34, the data DN22 is fetched into the processor 2.

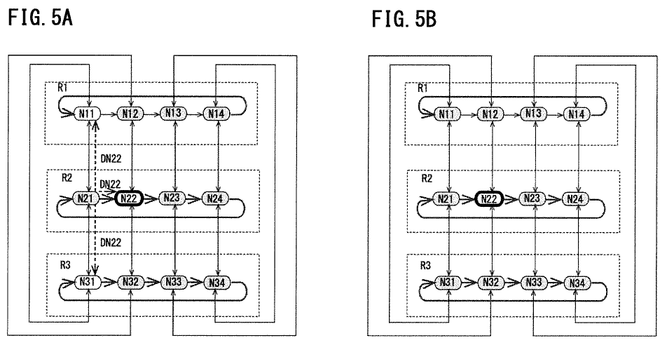

Next, as illustrated in FIG. 5A, the node N21 to which the data DN22 is transferred from the node N24 transfers the transferred data DN22 to the node N22 next to the node N2l on the ring R2, and the node N11 of the ring R1 and the node N31 of the ring R3 which are nodes having the same order as that of the node N21 of other rings. Then, at the node N11 and the node N31, the data DN22 is fetched into the processor 2. Meanwhile, at the node N22, since the transferred data DN22 is data transmitted by its own processor 2, the data DN22 is discarded.

Then, as illustrated in FIG. 5B, the transfer of the data DN22 from the node N22 of the ring R2 as a transmission source to all the nodes of the ring R1, the ring R2, and the ring R3 is completed.

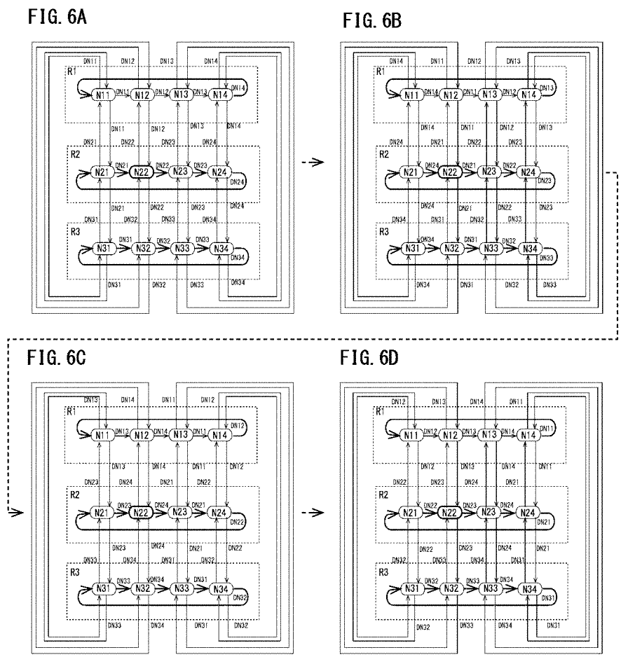

Next, FIGS. 6A to 6D illustrate the state of transfer in the distributed processing system when all the nodes are synchronized with each other, and the own nodes serve as transmission sources to transmit data at the same time.

Here, in FIGS. 6A to 6D, DNij indicates data of which a transmission source is a j^{th} node of an i^{th} ring. Further, FIG. 6A illustrates a first transfer, FIG. 6B illustrates a second transfer, FIG. 6C illustrates a third transfer, and FIG. 6D illustrates a fourth transfer.

As illustrated, in this case, the transfer of data transmitted from each node as a transmission source to all the other nodes is completed by the four transfers. In other words, each node may acquire data transmitted from all the other nodes as transmission sources by the four transfers.

Further, as illustrated, in each transfer, each data is transferred using different channels, and all the channels are used for the data transfer. Therefore, the data transfer is performed using the channels evenly and efficiently.

The first exemplary embodiment of the present invention has been described.

In the first exemplary embodiment described above, when data to be transferred from the processor 2 to each of the other nodes occurs, the data is transferred to a node having the same order as the relevant node in the other rings. However, when the data circulates around the ring and returns, the node may transfer the data to a node having the same order as the relevant node in the other rings.

In this manner, according to the configuration of the distributed processing system of the first exemplary embodiment, since the maximum value of hops expressed as the number of nodes passed by data may be reduced, as compared with the ring type network in which all the nodes included in the distributed processing system are connected to each other in a ring shape, the time taken to complete the transfer of data of a node to all the other nodes may be reduced. Meanwhile, the number of required channels is small, as compared with the full connection type network in which each node is connected directly to the other nodes by channels.

Further, according to the first exemplary embodiment, the load of each channel between nodes in the same ring or the load of each channel between nodes of different rings may be equalized, and each channel may be effectively used.

Thus, the transfer of data of a node to all the other nodes may be completed in a relatively short time while suppressing the number of channels.

Therefore, according to the present exemplary embodiment, the transfer of data of anode to all other nodes may be completed in a relatively short time while suppressing the number of channels.

Hereinafter, a second exemplary embodiment of the present invention will be described.

The distributed processing system according to the second exemplary embodiment has substantially the same configuration as that of the distributed processing system according to the first exemplary embodiment illustrated in FIG. 1. Further, the configuration of each node according to the second exemplary embodiment also is substantially the same as that of the node according to the first exemplary embodiment illustrated in FIG. 2.

Further, buffers of the transfer control device 3 of each node according to the second exemplary embodiment also are substantially the same as the buffers of the transfer control device 3 of each node in the first exemplary embodiment illustrated in FIG. 3.

Meanwhile, the transfer operation between the buffers performed by the transfer control device 3 of each node according to the second exemplary embodiment is different from that in the first exemplary embodiment.

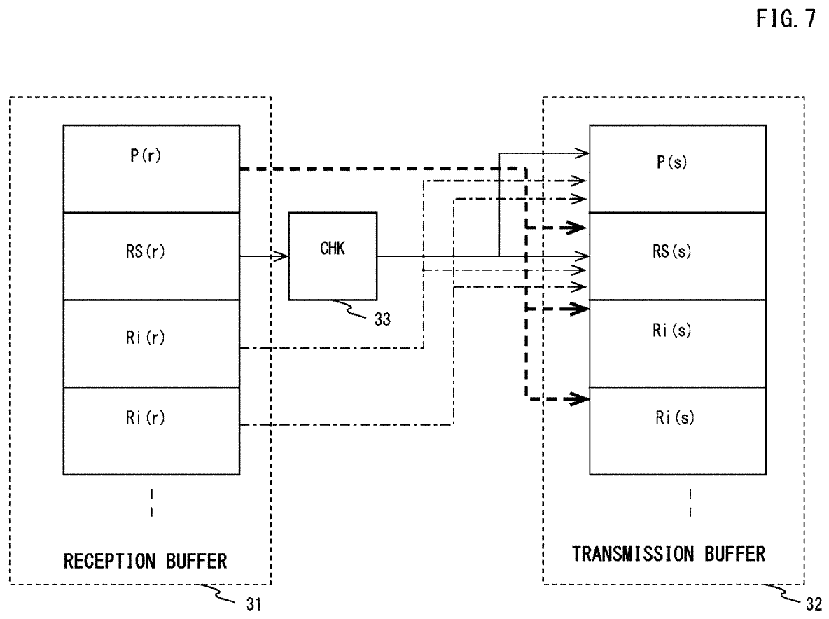

That is, in the second exemplary embodiment, as illustrated in FIG. 7, in the transfer control device 3, the data stored in the buffer P(r) of the reception buffer 31 by the processor 2 is transferred to the buffer RS(s) and each buffer Ri (s) of the transmission buffer 32, and is transmitted to a node included in the same ring as that of the relevant node and next to the relevant node in the order on the ring, and a node having the same order as that of the relevant node in each of the other rings different from the ring including the relevant node.

Further, the data received from the node included in the same ring as that of the relevant node and previous to the relevant node in the order on the ring, and stored in the buffer RS (r) of the reception buffer 31 is transferred to the duplicate transfer inhibition unit CHK33. The duplicate transfer inhibition unit CHK33 determines whether or not the transferred data is data that was transmitted in the past by its own node as a transmission source to other nodes, or data that was transferred in the past by its own node to a node included in the same ring as that of the relevant node and next to the relevant node in the order on the ring, and outputs the data only when it is determined that the transferred data is not the data that was transmitted by its own node as a transmission source to other nodes or the data that was transferred by its own node to a node included in the same ring as that of the relevant node and being next to the relevant node in the order on the ring.

Then, the transfer control device 3 transfers the data output from the duplicate transfer inhibition unit CHK33 to the buffer P (s) and the buffer RS (s) of the transmission buffer 32 and transmits the data to the processor 2 and a node included in the same ring as that of the relevant node and next to the relevant node in the order on the ring.

Further, the data received from the node having the same order as that of the relevant node in the order on the ring in each of the other rings different from the ring including the relevant node, and stored in each Ri(r) is transferred to the buffer P(s) and the buffer RS (s) of the transmission buffer 32 and is transmitted to the processor 2 and a node included in the same ring as that of the relevant node and next to the relevant node in the order on the ring.

The processor 2 receives and processes the data transmitted from the transfer control device 3 in this manner, that is, data that was not transmitted in the past from the processor 2 to other nodes, among the data received from the node included in the same ring as that of the relevant node and previous to the relevant node in the order on the ring, and data received from a node included in other rings different from the ring including the relevant node and having the same order as that of the relevant node in the order on the ring.

Hereinafter, the data transfer operation implemented by the operation of the transfer control device 3 will be described.

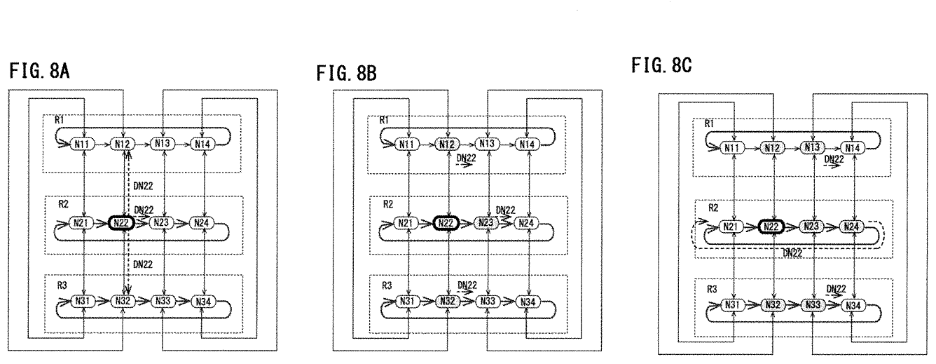

When data DN22 to be transferred from the processor 2 to other nodes occurs at the node N22 of the ring R2 as illustrated in FIG. 8A, the data DN22 is transferred from the node N22 to the node N23 next to the node N22 on the ring R2, and the node N12 of the ring R1 and the node N32 of the ring R3 which are nodes having the same order as that of the node N22 of the other rings. Then, at the node N23, the node N13, and the node N33, the data DN22 is fetched into the processor 2.

In each of the following figures, each round square representing a node to which the data DN22 is transferred is painted in gray.

Next, as illustrated in FIG. 8B, the node N23 to which the data DN22 is transferred from the node N22 transfers the transferred data DN22 to the node N24 next to the node N23 on the ring R2. In addition, the node N12 to which the data DN22 is transferred from the node N22 transfers the transferred data DN22 to the node N13 next to the node N12 on the ring R1, and the node N32 to which the data DN22 is transferred from the node N22 transfers the transferred data DN22 to the node N33 next to the node N32 on the ring R3. Then, at the node N24, the node N13, and the node N33, the data DN22 is fetched into the processor 2.

Next, as illustrated in FIG. 8C, the node N24 to which the data DN22 is transferred from the node N23 transfers the transferred data DN22 to the node N2l next to the node N24 on the ring R2. In addition, the node Nl3 to which the data DN22 is transferred from the node N12 transfers the transferred data DN22 to the node Nl4 next to the node Nl3 on the ring R1, and the node N33 to which the data DN22 is transferred from the node N32 transfers the transferred data DN22 to the node N34 next to the node N33 on the ring R3. Then, at the node N21, the node N14, and the node N34, the data DN22 is fetched into the processor 2.

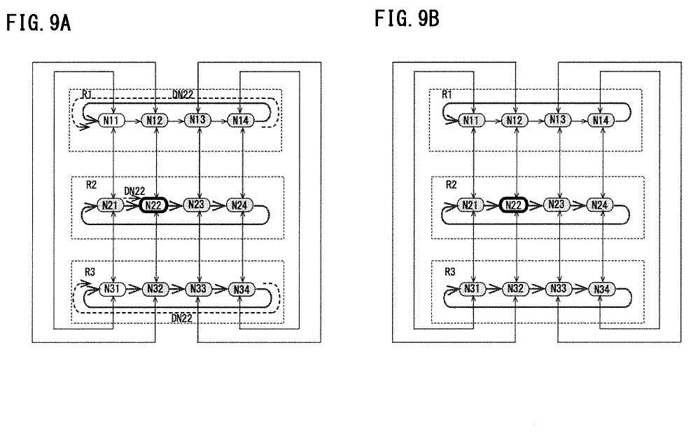

Next, as illustrated in FIG. 9A, the node N2l to which the data DN22 is transferred from the node N24 transfers the transferred data DN22 to the node N22 next to the node N21 on the ring R2. In addition, the node Nl4 to which the data DN22 is transferred from the node Nl3 transfers the transferred data DN22 to the node N11 next to the node N14 on the ring R1, and the node N34 to which the data DN22 is transferred from the node N33 transfers the transferred data DN22 to the node N31 next to the node N34 on the ring R3.

Then, at the node N11 and the node N31, the data DN22 is fetched into the processor 2. Meanwhile, at the node N22, since the transferred data DN22 is data transmitted by its own processor 2, the data DN22 is discarded.

As a result, as illustrated in FIG. 9B, the transfer of the data DN22 from the node N22 of the ring R2 as a transmission source to all the other nodes of the ring R1, the ring R2, and the ring R3 is completed.

In this manner, according to the configuration of the distributed processing system of the second exemplary embodiment as well, since the maximum value of the number of hops expressed as the number of nodes passed by data may be reduced, as compared with the ring type network in which all the nodes included in the distributed processing system are connected to each other in a ring shape, time taken to complete the transfer of data of a node to all the other nodes may be reduced. Meanwhile, the number of required channels is small, as compared with the full connection type network in which each node is connected directly to the other nodes by channels.

Thus, according to the second exemplary embodiment, the transfer of data of a node to all the other nodes may be completed in a relatively short time while suppressing the number of channels.

However, in the second exemplary embodiment, as compared with the first embodiment, the load of the channels in each ring increases. Therefore, in the second exemplary embodiment, the loads may be distributed by multiplexing the channels in each ring.

The second exemplary embodiment of the present invention has been described.

By the way, in the first and second exemplary embodiments described above, the connection of nodes between rings is made by connecting the j^{th} node of the i^{th} ring to the j^{th} node of each ring other than the i^{th} ring by a bidirectional channel. However, the connection of the nodes between the rings may be made in an arbitrary connection form as long as a channel on which each node of the i^{th} ring becomes a transmitting side can be connected to different nodes of the other rings as a channel on a receiving side.

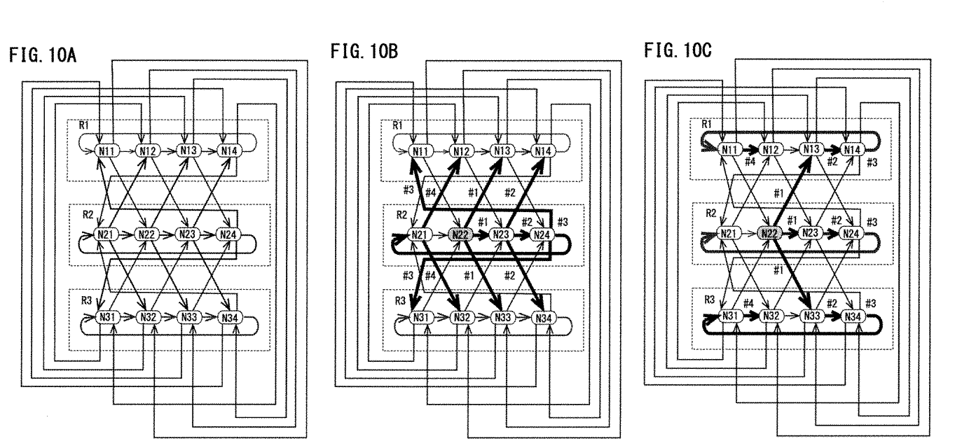

For example, as illustrated in FIG. 10A, the connection between rings in the first and second exemplary embodiments may be made by connecting a unidirectional channel on which the j^{th} node of the i^{th} ring becomes a transmitting side to the (j+1)^{th} node of each ring other than the i^{th} ring such that the unidirectional channel becomes a unidirectional channel at a receiving side of the (j+1)^{th} node of each ring other than the i^{th} ring. Where Z is the number of nodes in each ring, the unidirectional channel on which the Z^{th} node of the i^{th} ring becomes a transmitting side is connected to the first node of each ring other than the i^{th} ring such that the unidirectional channel becomes a unidirectional channel at a receiving side of the first node of each ring other than the i^{th} ring.

Here, the thick line in FIG. 10B indicates a transfer route of data generated at the node N22 of the ring R2 when the connection between rings is made as illustrated in FIG. 10A in the first exemplary embodiment. The symbol “x” in #x in the figure indicates the x^{th} transfer of data between nodes.

As can be understood from the comparison between FIG. 10B and FIGS. 4A to 5B, data may be transferred from any node to all the other nodes with the same number of times of transfers (four times in the case of FIGS. 10B, 4A to 5B) as that in the first exemplary embodiment.

Next, the thick line in FIG. 10C indicates a transfer route of data generated at the node N22 of the ring R2 when the connection between rings is made as illustrated in FIG. 10A in the second exemplary embodiment. In FIG. 10C, the symbol “x” in #x indicates the x^{th} transfer of data between nodes.

As can be understood from the comparison between FIG. 10C and FIGS. 8A to 9B, data may be transferred from any node to all the other nodes with the same number of times of transfers (four times in the case of FIGS. 10C, 8A to 9B) as that in the second exemplary embodiment.

In the meantime, each of the distributed processing systems according to the first and second exemplary embodiments may be configured to be divided into a plurality of distributed processing systems.

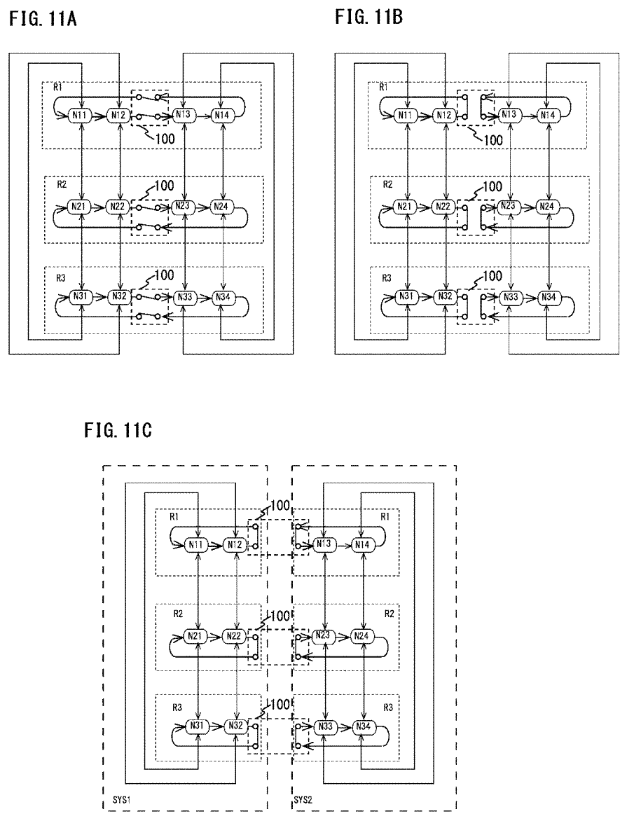

That is, when the connection between rings in each of the distributed processing systems according to the first and second exemplary embodiments is the connection illustrated in FIG. 1, a switch 100 may be provided, and the network configuration may be changed according to the setting of the switch 100, as illustrated in, for example, FIG. 11A.

In the configuration of the distributed processing system of FIG. 1, the illustrated switch 100 is provided to selectively connect a reception channel of the node N13 to a transmission channel of the node N12 and a transmission channel of the node N14, selectively connect a reception channel of the node N11 to a transmission channel of the node N14 and a transmission channel of the node N12, selectively connect a reception channel of the node N23 to a transmission channel of the node N22 and a transmission channel of the node N24, selectively connect a reception channel of the node N21 to the transmission channel of the node N24 and the transmission channel of the node N22, selectively connect a reception channel of the node N33 to a transmission channel of the node N32 and a transmission channel of the node N34, and selectively connect a reception channel of the node N31 to the transmission channel of the node N34 and the transmission channel of the node N32.

With such a switch 100, as illustrated in FIG. 11A, when the reception channel of the node N13 is connected to the transmission channel of the node N12, the reception channel of the node N11 is connected to the transmission channel of the node N14, the reception channel of the node N23 is connected to the transmission channel of the node N22, the reception channel of the node N21 is connected to the transmission channel of the node N24, the reception channel of the node N33 is connected to the transmission channel of the node N32, and the reception channel of the node N31 is connected to the transmission channel of N34, it is possible to construct one distributed processing system having three rings each having 4 nodes, which is the same as the distributed processing system illustrated in FIG. 1.

Meanwhile, as illustrated in FIG. 11B, when the reception channel of the node N13 is connected to the transmission channel of the node N14, the reception channel of the node N11 is connected to the transmission channel of the node N12, the reception channel of the node N23 is connected to the transmission channel of the node N24, the reception channel of the node N21 is connected to the transmission channel of the node N22, the reception channel of the node N33 is connected to the transmission channel of the node N34, and the reception channel of the node N31 is connected to the transmission channel of the node N32, it is possible to construct two distributed processing systems including a distributed processing system SYS1 and a distributed processing system SYS2, each of which has three rings each having two nodes, as illustrated in FIG. 11C.

In the case where the connection between rings in each of the distributed processing systems according to the first and second exemplary embodiments is made such that a unidirectional channel on which the j^{th} node of the i^{th} ring as illustrated in FIG. 10A becomes a transmitting side becomes a unidirectional channel at a receiving side of the (j+1)^{th} node of each ring other than the i^{th} ring, the switch 100 may be provided and the network configuration may be changed according to the setting of the switch 100 in the same way.

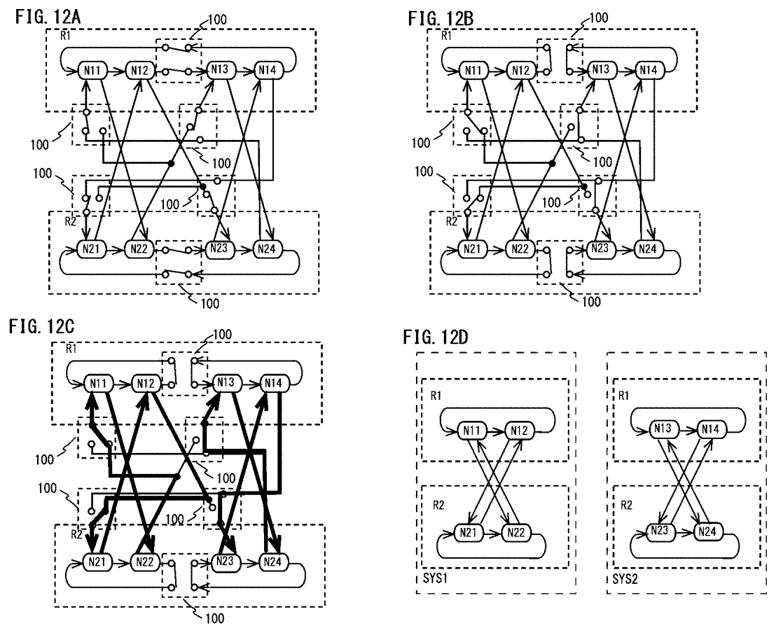

That is, as illustrated with a distributed processing system having two rings, each having four nodes, in FIG. 12A, by also providing the switch 100 as illustrating in this figure, depending on the setting of the switch 100, it is possible to construct one distributed processing system having three rings, each having 4 nodes, as illustrated in FIG. 12A, or two distributed processing systems, each of which has three rings, each having 2 nodes, as illustrated in FIG. 12B.

FIG. 12C illustrates that the connection between rings when the switch 100 illustrated in FIG. 12B is set is indicated by a thick line, and FIG. 12D illustrates the two distributed processing systems SYS1 and SYS2 configured when the switch 100 illustrated in FIG. 12B is set.

Hereinafter, a third exemplary embodiment of the present invention will be described.

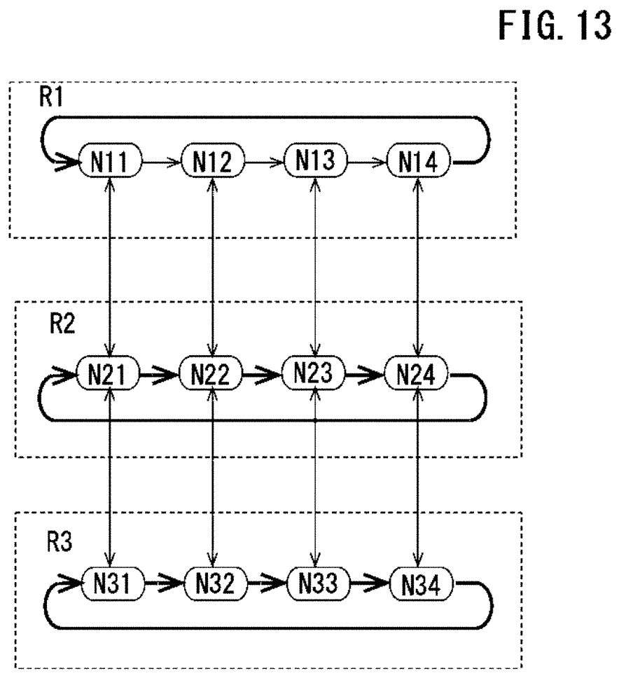

FIG. 13 illustrates the configuration of a distributed processing system according to the third exemplary embodiment.

As illustrated, the distributed processing system has a plurality of rings (Ri), each of which includes the same number of nodes (Nij), as in the first embodiment.

In each of the rings, a ring type network is formed in which nodes included in the ring are sequentially connected to each other in a ring shape by channels.

The j^{th} node of the i^{th} ring is connected to the j^{th} node of the (i+1)^{th} ring by a bidirectional channel.

For example, in the illustrated example, the second node N12 of the ring R1 is connected to the second node N22 of the ring R2 next to the ring R1 by a channel, and the second node N22 of the ring R2 is connected to the second node N32 of the ring R3 next to the ring R2 by a channel.

The configuration of each node according to the third exemplary embodiment is the same as that of the first exemplary embodiment illustrated in FIG. 2.

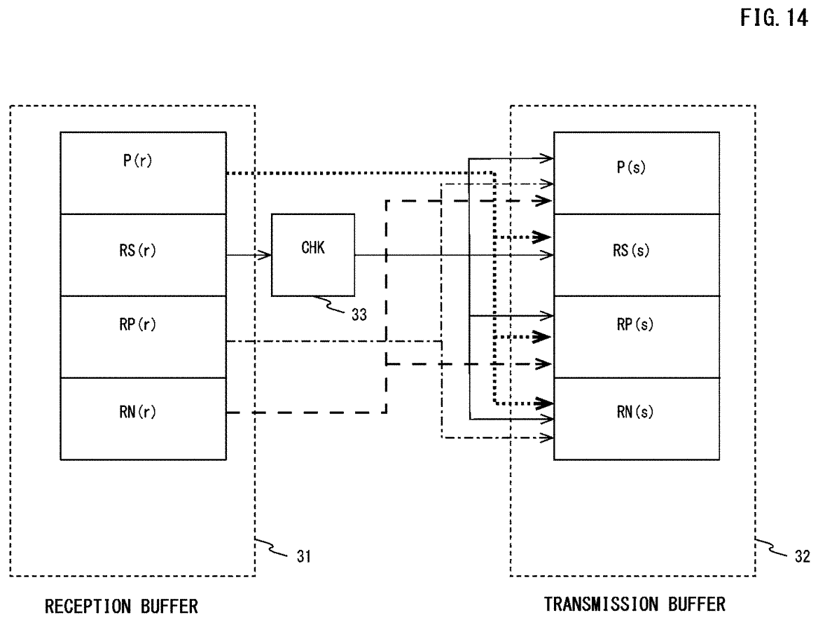

However, the transfer control device 3 according to the third exemplary embodiment has the buffer configuration illustrated in FIG. 14, instead of the configuration according to the first exemplary embodiment illustrated in FIG. 3.

That is, the transfer control device 3 according to the third exemplary embodiment includes a reception buffer 31, a transmission buffer 32, and a duplicate transfer inhibition unit CHK33, similarly to the configuration according to the first exemplary embodiment illustrated in FIG. 2.

However, unlike the first exemplary embodiment, the reception buffer 31 includes a buffer P(r) that stores data to be transmitted to other nodes by the processor 2, a buffer RS(r) that stores data received by the channel interface 4 from a node included in the same ring as that of the relevant node and previous to the relevant node in the order on the ring, a buffer RP(r) that stores data received by the channel interface 4 from a node included in a ring previous to the ring including the relevant node and having the same order as that of the relevant node in the order on the ring, and a buffer RN (r) that stores data received by the channel interface 4 from a node included in the ring next to the ring including the relevant node and having the same order as that of the relevant node in the order on the ring.

For example, for the third node N23 of the ring R2 in FIG. 13, data received from the node N22 is stored in the buffer RS(r). Data received from the third node N13 of the ring R1 is stored in the buffer RP(r). Data received from the third node N33 of the ring R3 is stored in the buffer RN(r).

In addition, the transmission buffer 32 includes a buffer P(s) that stores data to be transmitted to the processor 2, a buffer RS(s) that stores data to be transmitted via the channel interface 4 to a node included in the same ring as that of the relevant node and next to the relevant node in the order on the ring, a buffer RP(s) that stores data to be transmitted via the channel interface 4 to a node included in the ring previous to the ring including the relevant node and having the same order as that of the relevant node in the order on the ring, and a buffer RN(s) that stores data to be transmitted via the channel interface 4 to a node included in the ring next to the ring including the relevant node and having the same order as that of the relevant node in the order on the ring.

For example, for the third node N23 of the ring R2 in FIG. 13, data to be transmitted to the node N24 is stored in the buffer RS(s). Data to be transmitted to the third node N13 of the ring R1 is stored in the buffer RP(s). Data to be transmitted to the third node N33 of the ring R3 is stored in the buffer RN(s).

Then, the transfer control device 3 performs transfer between buffers as follows.

That is, the data stored in the buffer P(r) of the reception buffer 31 by the processor 2 is transferred to the buffer RS(s), the buffer RP(s), and the buffer RN(s) of the transmission buffer 32, and is transmitted to a node included in the same ring as that of the relevant node and next to the relevant node in the order on the ring, a node included in the ring previous to the ring including the relevant node and having the same order as that of the relevant node in the order on the ring, and a node included in the ring next to the ring including the relevant node and having the same order as that of the relevant node in the order on the ring.

Further, the data received from the node included in the same ring as that of the relevant node and previous to the relevant node in the order on the ring and stored in the buffer RS (r) of the reception buffer 31 is transferred to the duplicate transfer inhibition unit CHK33. The duplicate transfer inhibition unit CHK33 determines whether or not the transferred data is data that was transmitted in the past by its own node as a transmission source to other nodes, and outputs the data only when it is determined that the transferred data is not the data that was transmitted by its own node as a transmission source to the other nodes.

Then, the transfer control device 3 transfers the data output from the duplicate transfer inhibition unit CHK33 to the buffer P(s), the buffer RS(s), the buffer RP(s) and the buffer RN(s) of the transmission buffer 32, and transmits the data to the processor 2, a node included in the same ring as that of the relevant node and next to the relevant node in the order on the ring, a node included in the ring previous to the ring including the relevant node and having the same order as that of the relevant node in the order on the ring, and a node included in the ring next to the ring including the relevant node and having the same order as that of the relevant node in the order on the ring.

Further, the data received from the node included in the ring previous to the ring including the relevant node and having the same order as that of the relevant node in the order on the ring and stored in the buffer RP(r) is transferred to the buffer P(s) and the buffer RN(s) of the transmission buffer 32, and is transmitted to the processor 2 and the node included in the ring next to the ring including the relevant node and having the same order as that of the relevant node in the order on the ring.

Further, the data received from the node included in the ring next to the ring including the relevant node and having the same order as that of the relevant node in the order on the ring and stored in the buffer RN(r) is transferred to the buffer P(s) and the buffer RP(s) of the transmission buffer 32 and is transmitted to the processor 2 and the node included in the ring previous to the ring including the relevant node and having the same order as that of the relevant node in the order on the ring.

The processor 2 receives and processes the data transmitted from the transfer control device 3 in this manner, that is, data that was not transmitted in the past from the processor 2 to other nodes among the data received from the node included in the same ring as that of the relevant node and previous to the relevant node in the order on the ring, the data received from the node included in the ring previous to the ring including the relevant node and having the same order as that of the relevant node in the order on the ring, and the data received from the node included in the ring next to the ring including the relevant node and having the same order as that of the relevant node in the order on the ring.

Hereinafter, the data transfer operation implemented by the operation of the transfer control device 3 will be described.

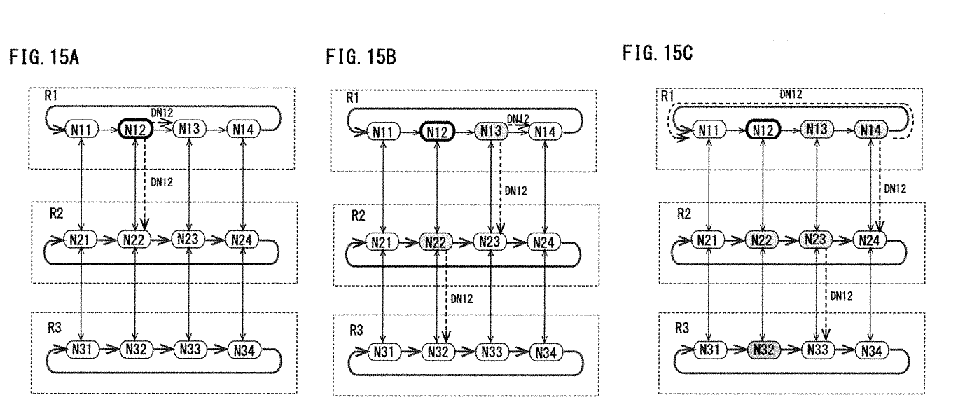

When data DN12 to be transferred from the processor 2 to other nodes occurs at the node N12 of the ring R1 as illustrated in FIG. 15A, the data DN12 is transferred from the node N12 to the node N13 next to the node N12 on the ring R1 and the node N22 included in the ring R2 next to the ring R1 and having the same order as that of the node N12. Then, at the node N13 and the node N22, the data DN12 is fetched into the processor 2.

In each of the following figures, each round square representing a node to which the data DN12 is transferred is painted in gray.

Next, as illustrated in FIG. 15B, the node N13 to which the data DN12 is transferred from the node N12 transfers the transferred data DN12 to the node N14 next to the node N13 on the ring R1 and the node N23 included in the ring R2 next to the ring R1 and having the same order as that of the node N13. In addition, the node N22 of the ring R2 to which the data DN12 is transferred from the node N12 transfers the transferred data DN12 to the node N32 included in the ring R3 next to the ring R2 and having the same order as that of the node N22.

Then, at the node N14, the node N23 and the node N32, the data DN12 is fetched into the processor 2.

Next, as illustrated in FIG. 15C, the node N14 to which the data DN12 is transferred from the node N13 transfers the transferred data DN12 to the node N11 next to the node N14 on the ring R1 and the node N24 included in the ring R2 next to the ring R1 and having the same order as that of the node N14. In addition, the node N23 of the ring R2 to which the data DN12 is transferred from the node N13 transfers the transferred data DN12 to the node N33 included in the ring R3 next to the ring 2 and having the same order as that of the node N23.

Then, at the node N11, the node N24, and the node N33, the data DN12 is fetched into the processor 2.

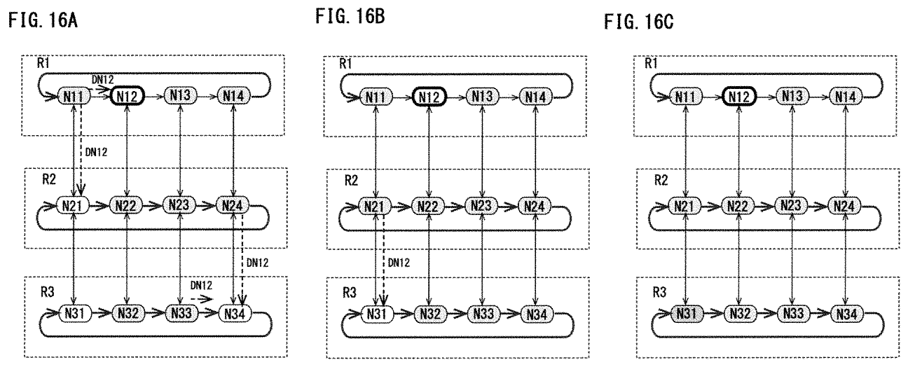

Next, as illustrated in FIG. 16A, the node N11 to which the data DN12 is transferred from the node N14 transfers the transferred data DN12 to the node N12 next to the node Nil on the ring R1 and the node N21 included in the ring R2 next to the ring R1 and having the same order as that of the node Nil. In addition, the node N24 of the ring R2 to which the data DN12 is transferred from the node N14 transfers the transferred data DN12 to the node N34 included in the ring R3 next to the ring R2 and having the same order as that of the node N24.

Then, at the node N21 and the node N34, the data DN12 is fetched into the processor 2. Meanwhile, at the node N12, since the transferred data DN12 is the data that was transmitted by its own processor 2, the transferred data DN12 is discarded.

Next, as illustrated in FIG. 16B, the node N21 of the ring R2 to which the data DN12 is transferred from the node N11 transfers the transferred data DN12 to the node N31 included in the ring R3 next to the ring R2 and having the same order as that of the node N21.

As a result, as illustrated in FIG. 16C, the transfer of the data DN12 from the node N12 of the ring R1 as a transmission source to all the other nodes of the ring R1, the ring R2, and the ring R3 is completed.

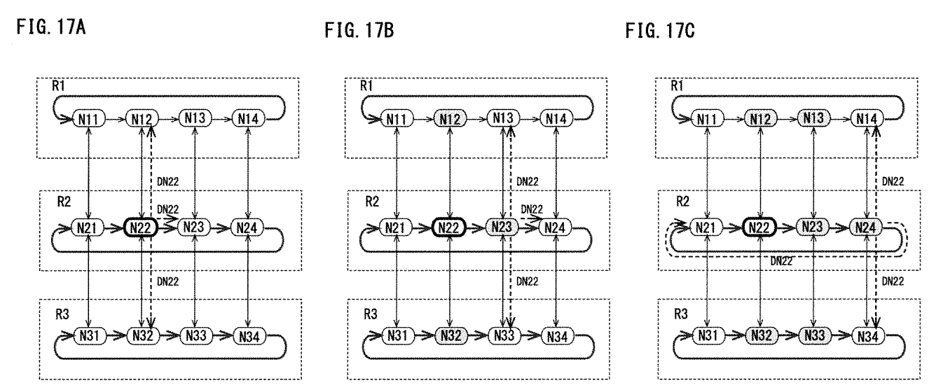

Next, when data DN22 to be transferred from the processor 2 to other nodes occurs at the node N22 of the ring R2 as illustrated in FIG. 17A, the data DN22 is transferred from the node N22 to the node N23 next to the node N22 on the ring R2, the node N12 included in the ring R1 previous to the ring R2 and having the same order as that of the node N22, and the node N32 included in the ring R3 next to the ring R2 and having the same order as that of the node N22. Then, at the node N23, the node N12, and the node N32, the data DN22 is fetched into the processor 2.

Next, as illustrated in FIG. 17B, the node N23 to which the data DN22 is transferred from the node N22 transfers the transferred data DN22 to the node N24 next to the node N23 on the ring R2, the node N13 included in the ring R1 previous to the ring R2 and having the same order as that of the node N23, and the node N33 included in the ring R3 next to the ring R2 and having the same order as that of the node N23. Then, at the node N24, the node N13, and the node N33, the data DN22 is fetched into the processor 2.

Next, as illustrated in FIG. 17C, the node N24 to which the data DN22 is transferred from the node N23 transfers the transferred data DN22 to the node N21 next to the node N24 on the ring R2, the node N14 included in the ring R1 previous to the ring R2 and having the same order as that of the node N24, and the node N34 included in the ring R3 next to the ring R2 and having the same order as that of the node N24. Then, at the node N21, the node N14, and the node N34, the data DN22 is fetched into the processor 2.

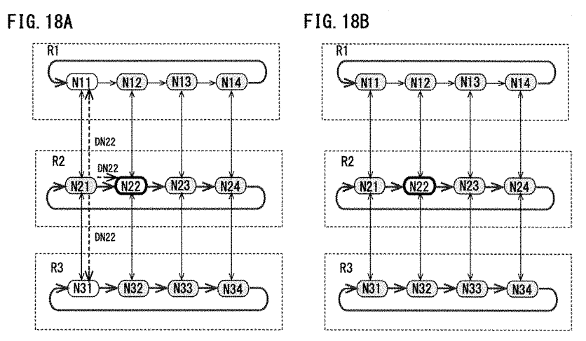

Next, as illustrated in FIG. 18A, the node N21 to which the data DN22 is transferred from the node N24 transfers the transferred data DN22 to the node N22 next to the node N21 on the ring R2, the node Nil included in the ring R1 previous to the ring R2 and having the same order as that of the node N21, and the node N31 included in the ring R3 next to the ring R2 and having the same order as that of the node N21. Then, at the node Nil and the node N31, the data DN22 is fetched into the processor 2. Meanwhile, at the node N22, since the transferred data DN22 is the data that was transmitted by its own processor 2, the transferred data DN22 is discarded.

As a result, as illustrated in FIG. 18B, the transfer of the data DN22 from the node N12 of the ring R1 as a transmission source to all the other nodes of the ring R1, the ring R2, and the ring R3 is completed.

The third exemplary embodiment of the present invention has been described.

In the third exemplary embodiment described above, when data to be transferred from the processor 2 to each of the other nodes is generated, the data is transferred to the relevant node of the other rings. However, when the data circulates around the ring and returns, the node may transfer the data to the relevant node of the other rings.

According to the third exemplary embodiment, while the time taken to complete the transfer of data of a node to all other nodes is longer than that in the first exemplary embodiment depending on the number of rings, the number of channels required may be reduced, as compared with the first exemplary embodiment.

Hereinafter, a fourth exemplary embodiment of the present invention will be described.

A distributed processing system according to the fourth exemplary embodiment has substantially the same configuration as that of the distributed processing system according to the third exemplary embodiment illustrated in FIG. 13. Further, the configuration of each node according to the fourth exemplary embodiment also is substantially the same as that of the node according to the third exemplary embodiment.

Buffers of the transfer control device 3 of each node according to the fourth exemplary embodiment also are substantially the same as the buffers of the transfer control device 3 of each node in the third exemplary embodiment illustrated in FIG. 14.

Meanwhile, the transfer operation between buffers performed by the transfer control device 3 of each node according to the fourth exemplary embodiment is different from that in the third exemplary embodiment.

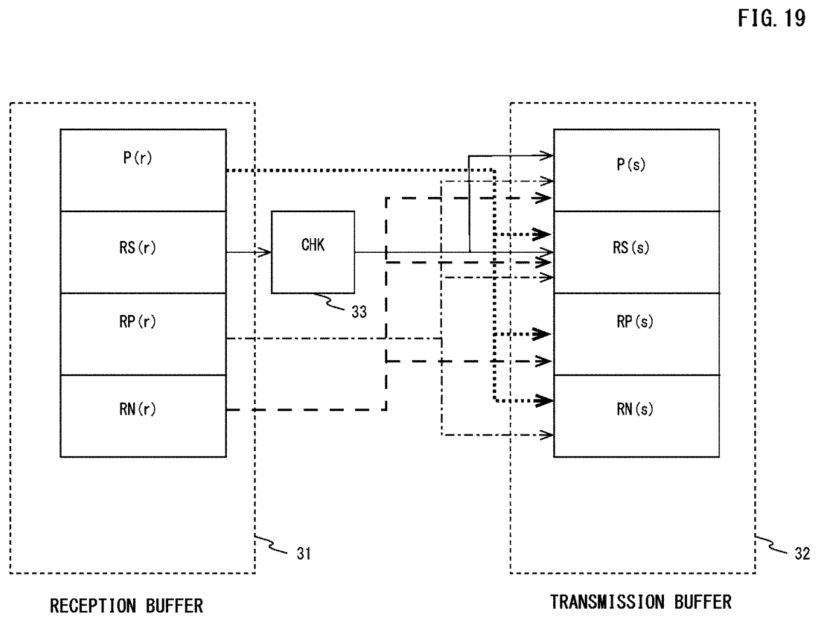

That is, the transfer control device 3 performs the transfer between buffers as illustrated in FIG. 19.

Specifically, the data stored in the buffer P(r) of the reception buffer 31 by the processor 2 is transferred to the buffer RS(s), the buffer RP(s), and the buffer RN(s) of the transmission buffer 32 and is transmitted to a node included in the same ring as that of the relevant node and next to the relevant node in the order on the ring, a node included in the ring previous to the ring including the relevant node and having the same order as that of the relevant node in the order on the ring, and a node included in the ring next to the ring including the relevant node and having the same order as that of the relevant node in the order on the ring.

Further, the data received from the node included in the same ring as that of the relevant node and previous to the relevant node in the order on the ring and stored in the buffer RS (r) of the reception buffer 31 is transferred to the duplicate transfer inhibition unit CHK33. The duplicate transfer inhibition unit CHK33 determines whether or not the transferred data is data that was transmitted in the past by its own node as a transmission source to other nodes, or data that was transferred in the past by its own node to the node included in the same ring as that of the relevant node and next to the relevant node in the order on the ring, and outputs the data only when it is determined that the transferred data is not the data that was transmitted from its own node as a transmission source to the other nodes or the data that was transferred by its own node to the node included in the same ring as that of the relevant node and next to the relevant node in the order on the ring.

Then, the transfer control device 3 transfers the data output from the duplicate transfer inhibition unit CHK33 to the buffer P(s) and the buffer RS(s) of the transmission buffer 32 and transmits the data to the processor 2 and a node included in the same ring as that of the relevant node and next to the relevant node in the order on the ring.

Further, the data received from the node included in the ring previous to the ring including the relevant node and having the same order as that of the relevant node and stored in the buffer RP(r) is transferred to the buffer P(s), the buffer RN(s) , and the buffer RS(s) of the transmission buffer 32 and is transmitted to the processor 2, the node included in the ring next to the ring including the relevant node and having the same order as that of the relevant node in the order on the ring, and the node included in the same ring as that of the relevant node and next to the relevant node in the order on the ring.

Further, the data received from the node included in the ring next to the ring including the relevant node and having the same order as that of the relevant node in the order on the ring and stored in the buffer RN(r) is transferred to the buffer P(s), the buffer RP(s), and the buffer RS(s) of the transmission buffer 32 and is transmitted to the processor 2, the node included in the ring previous to the ring including the relevant node and having the same order as that of the relevant node in the order on the ring, and the node included in the same ring as that of the relevant node and next to the relevant node in the order on the ring.

The processor 2 receives and processes the data transmitted from the transfer control device 3 in this manner, that is, data that was not transmitted in the past from the processor 2 to other nodes, among the data received from the node included in the same ring as that of the relevant node and previous to the relevant node in the order on the ring, the data received from the node included in the ring previous to the ring including the relevant node and having the same order as that of the relevant node in the order on the ring, and the data received from the node included in the ring next to the ring including the relevant node and having the same order as that of the relevant node in the order on the ring.

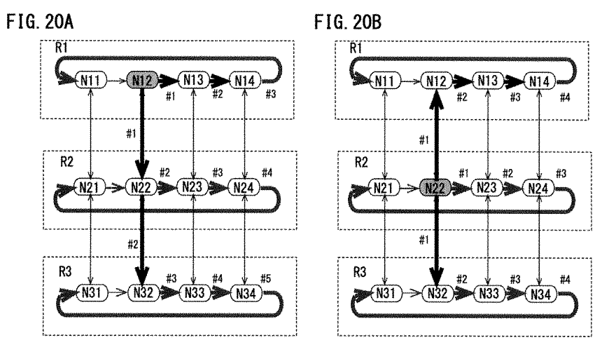

According to this transfer operation of the transfer control device 3, in the fourth exemplary embodiment, as can be seen from a transfer route (indicated by a thick line in FIG. 20A) of data generated at the node N12 of the ring R1 and a transfer route (indicated by a thick line in FIG. 20B) of data generated at the node N22 of the ring R2, data transfer of each node is performed as follows.

Specifically, a node as a transmission source of data transmits the data to a node next to the relevant node in the ring including the relevant node, and also transmits the data to a node of each of other rings connected by a channel. In addition, each node transmits the data received from the node of the previous ring connected by a channel to a node next to the relevant node in the ring including the relevant node, and also transmits the data to a node of the next ring connected by a channel. Further, each node transmits the data received from the node of the next ring connected by the channel to a node next to the relevant node in the ring including the relevant node, and also transmits the data to the node of the previous ring connected by a channel. In addition, each node transfers data, of which a transmission source is not the relevant node and which was not transmitted in the past by the relevant node to the node next to the relevant node in the ring, among the data received from the node previous to the relevant node in the ring including the relevant node, to the node next to the relevant node in the ring including the relevant node.

Here, the symbol “x” in #x in FIGS. 20A and 20B indicates x^{th} transfer of data between nodes.

As can be understood from the comparison between FIG. 20A and FIGS. 15A to 16C and the comparison between FIG. 20B and FIGS. 17A to 18B, even when the transfer is performed in this way, data may be transferred from any node to all other nodes with the same number of times of transfers (five times in the case of FIGS. 20A, 15A to 16C, and four times in the case of FIGS. 20B, 17A to 18B) as that in the third exemplary embodiment.

However, in the fourth exemplary embodiment, the load of the channels in each ring increases, as compared to the third exemplary embodiment. Therefore, in the fourth exemplary embodiment, the load may be distributed by multiplexing the channels in each ring.

In the third and fourth exemplary embodiments described above, connection of nodes between rings is made by connecting the j^{th} node of the i^{th} ring to the j^{th} node of each ring other than the i^{th} ring by a bidirectional channel. However, even in the third and fourth exemplary embodiments, similarly to the first and second exemplary embodiments, the connection of the nodes between the rings may be made in an arbitrary connection form as long as a channel on which each node of the i^{th} ring becomes a transmitting side can be connected to different nodes of the previous ring and the next ring as a channel on a receiving side.

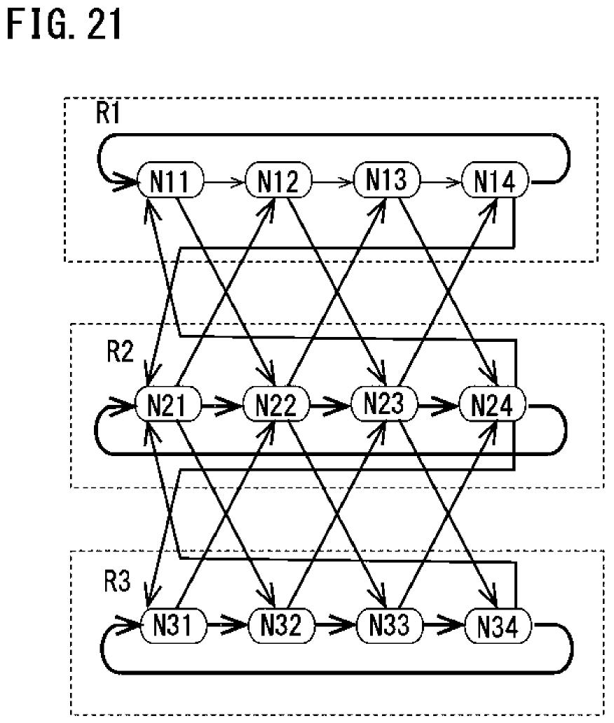

For example, as illustrated in FIG. 21, the connection between rings in the third and fourth exemplary embodiments may be made by connecting a unidirectional channel on which the j^{th} node of the i^{th} ring becomes a transmitting side such that the unidirectional channel becomes a unidirectional channel at a receiving side of the (j+1)^{th} node of the (i+1)^{th} ring and also connecting a unidirectional channel on which the j^{th} node of i^{th} ring becomes a transmitting side such that the unidirectional channel becomes a unidirectional channel at a receiving side of the (j+1)^{th} node of the (−1)^{th} ring. Where Z is the number of nodes in each ring, the unidirectional channel on which the Z^{th} node of the i^{th} ring becomes a transmitting side is connected such that the unidirectional channel becomes a unidirectional channel at a receiving side of the first nodes of the (i+1)^{th} ring and the (i−1)^{th} ring.

Data transfer may be performed in the same manner even with such connection between rings.

In addition, even in the distributed processing system according to the third and fourth exemplary embodiments, similarly to the first and second exemplary embodiments, a switch may be provided so as to divide the distributed processing system into a plurality of distributed processing systems. For example, if a switch is provided as illustrated in FIGS. 11A to 11C in the case where connection between rings as illustrated in FIG. 13 is made, and if a switch is provided as illustrated in FIGS. 12A to 12D when connection between rings as illustrated in FIG. 21 is made, it is possible to construct one distributed processing system with all nodes or construct two distributed processing systems by dividing the nodes of each ring.

The exemplary embodiments of the present invention have been described above.

Each of the rings in each of the exemplary embodiments described above may be formed by connecting a plurality of nodes in a ring shape with bidirectional channels. In this case, however, the processing on the data received from a previous node in the order on the ring in the same ring, which is performed in the transfer control device 3 as described above, is performed in each direction.

### EXPLANATION OF SYMBOLS

1 . . . storage, 2 . . . processor, 3 . . . transfer control device, 4 . . . channel interface, 31 . . . reception buffer, 32 . . . transmission buffer, 33 . . . duplicate transfer inhibition unit CHK, 100 . . . switch.

1.-15. (canceled)

16. A distributed processing system in which plurality of nodes are connected by channels, wherein the distributed processing system includes m rings (where m is an arbitrary natural number), each ring has n nodes (wherein n is an arbitrary natural number), and each ring is configured to transfer data at least in one direction, and wherein the distributed processing system has n groups, each group has m nodes by picking up one node from each ring, and the nodes within each group are connected by a fully connected network.

17. The distributed processing system according to claim 16, wherein each ring has switches to redirect communication data to another node, and the distributed processing system is divided into plural distributed processing systems by setting up said switches in each ring adequately.

18. The distributed processing system according to claim 16, wherein a node number is assigned to each node within each ring, and the nodes having the same node number are selected to constitute the groups, the nodes in each group are connected by a fully connected network.

19. The distributed processing system according to claim 18, wherein each ring has switches to redirect communication data to another node, and the distributed processing system is divided into plural distributed processing systems by setting up said switches located in the same positions in each ring adequately.

20. A method for dividing the distributed processing system of claim 16, the method comprising;
providing switches in each ring to redirect communication data to another node, and
setting up said switches in each ring adequately to divide the distributed processing system into plural distributed processing systems.
